(19) United States
(12) Patent Application Publication
(10) Pub. No.: US 2025/0250404 A1
(43) Pub. Date: Aug. 7, 2025

(54) STRUCTURE, METHOD OF MANUFACTURING STRUCTURE, AND HEAT INSULATING MATERIAL

(71) Applicant: Sony Group Corporation, Tokyo (JP)

(72) Inventor: Shigeru SAKAMOTO, Tokyo (JP)

(21) Appl. No.: 18/853,231

(22) PCT Filed: May 17, 2023
(86) PCT No.: PCT/JP2023/018492

§ 371 Date: Oct. 1, 2024

(30) Foreign Application Priority Data
Jul. 5, 2022 (JP) 2022-108616

(51) Int. Cl. C08J 9/00; B82Y 30/00; B82Y 40/00; C08K 3/34

(52) U.S. Cl. CPC C08J 9/0066; B82Y 30/00; B82Y 40/00; C08K 3/34; C08K 2201/011

(57) ABSTRACT

A nanomaterial structure is provided and includes a nanomaterial; and a nanomaterial cross-linking part including an inorganic oxide, wherein the nanomaterial is cross-linked with the nanomaterial cross-linking part.

### CROSS REFERENCE TO RELATED APPLICATIONS

This application claims the benefit of Japanese Priority Patent Application JP2022-108616 filed Jul. 5, 2022, the entire contents of which are incorporated herein by reference.

### TECHNICAL FIELD

The present disclosure relates to a structure including a nanomaterial, such as a nanoparticle, a nanofiber, a nanosheet or other nanomaterial of suitable size and shape, a method of manufacturing the structure, and a heat insulating material, for example.

### BACKGROUND ART

For example, PTL 1 discloses, as a heat insulating material having visible light transmissivity, a porous structure including a cross-linking body of a polymer compound selected from at least one of water-soluble polysaccharides or derivatives of water-soluble polysaccharides in which some of side-chain functional groups are chemically modified.

### CITATION LIST

### Patent Literature

[PTL 1] Japanese Unexamined Patent Application Publication No. 2017-039845

### SUMMARY

### Technical Problem

A heat insulating material is desired, for example, to have improved heat insulating characteristics.

It is desirable, for example, to provide a nanomaterial structure having heat insulating characteristics, a method of manufacturing the nanomaterial structure, and a heat insulating material.

### Solution to Problem

The present disclosure relates to a nanomaterial technology.

In an embodiment, a nanomaterial structure is provided and includes a nanomaterial; and a nanomaterial cross-linking part including an inorganic oxide, wherein the nanomaterial is cross-linked with the nanomaterial cross-linking part.

In an embodiment, a porous film or porous material is provided and includes a nanomaterial; and a nanomaterial cross-linking part including an inorganic oxide, wherein the nanomaterial is cross-linked with the nanomaterial cross-linking part.

In an embodiment, a method of manufacturing a nanomaterial structure is provided and includes providing a nanomaterial; providing a cross-linking agent including an inorganic oxide; and forming a nanomaterial cross-linked structure by cross-linking the nanomaterial with the cross-linking agent.

### BRIEF DESCRIPTION OF DRAWINGS

FIG. 1 is a schematic view of an example of an outline configuration of a structure according to an embodiment of the present disclosure.

FIG. 2 is a schematic view of a structure of a nanoparticle illustrated in FIG. 1.

FIG. 3 is an image diagram of a structure of the present embodiment upon being photographed using a transmission electron microscope.

FIG. 4 is a schematic view of an aspect of coupling between nanoparticles in a case of using the nanoparticle illustrated in FIG. 2.

FIG. 5A is an explanatory schematic view of conditions of a cross-linking part in which nanoparticles coupled to each other do not aggregate.

FIG. 5B is an explanatory schematic view of conditions of a cross-linking part in which nanoparticles coupled to each other do not aggregate.

FIG. 6 is a diagram illustrating a spatial arrangement of a plurality of nanoparticles coupled by the cross-linking part.

FIG. 7 is a flowchart illustrating manufacturing steps of the structure illustrated in FIG. 1.

FIG. 8 is a schematic view of an example of an outline configuration of a structure according to a modification example of the present disclosure.

FIG. 9 is a schematic view of another example of the outline configuration of the structure according to the modification example of the present disclosure.

FIG. 10 is a characteristic diagram illustrating a relationship between a transmittance and a particle diameter of a nanoparticle.

### DESCRIPTION OF EMBODIMENTS

In the following, description is given in detail of embodiments of the present technology with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.
1. An embodiment (An example of a structure including a plurality of nanoparticles coupled to each other via a cross-linking part including an inorganic oxide)
1-1. Configuration of Structure
1-2. Method of Manufacturing Structure
1-3. Workings and Effects
2. Modification Example (Another Example of Structure)
3. Another Application Example

### 1. Embodiment

### 1-1. Configuration of Structure

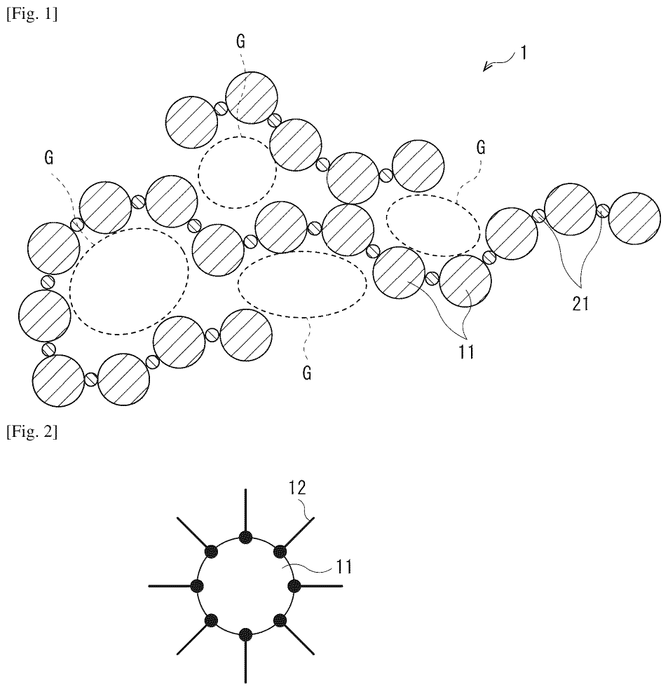

FIG. 1 schematically illustrates an example of a configuration of a structure (a structure 1) according to an embodiment of the present disclosure. The structure 1 is used, for example, as a heat insulating material that suppresses heat balance of a window by being attached to a glass window or being interposed between double windows, or as a transmitting body of a solar collector. In the structure 1 of the present embodiment, a plurality of nanoparticles 11, that are surface-coated with a methylsilyl group 12, are coupled to each other via a cross-linking part 21 including an inorganic oxide.

The nanoparticle 11 is, for example, a silica particle. An average particle diameter (median diameter) of the nanoparticle 11 is, for example, a diameter of 14 nm or less, and preferably 9 nm or less. The nanoparticle 11 is covalently bonded to a methylsilane compound to be deactivated, and is surface-coated with the methylsilyl group 12, for example, as illustrated in FIG. 2. This brings the plurality of nanoparticles 11 into a state of not being able to be covalently bonded to each other.

The average particle diameter (median diameter) of the nanoparticle 11 is determined as follows. First, the structure 1 as a measurement target is subjected to working by a Focused Ion Beam (FIB) method or the like to perform thinning. In a case where the FIB method is used, a carbon film and a tungsten thin film are formed as protective films as a treatment prior to observing a transmission electron microscope (TEM) image of a cross-section described later. The carbon film is formed on a surface of the structure 1 by a vapor deposition method. The tungsten thin film is formed on the surface of the structure 1 by a vapor deposition method or a sputtering method. This allows for formation of the cross-section of the structure 1 by the thinning.

The cross-section of an obtained thinned sample is subjected to cross-sectional observation using a transmission electron microscope (Tecnai G2 manufactured by FEI Ltd.) to enable the plurality of nanoparticles 11 to be observed at an acceleration voltage of 200 kV and at a field of view of 50 nm·˜50 nm, whereby a TEM photograph is taken. It is assumed that the photographing position is selected at random from the thinned sample.

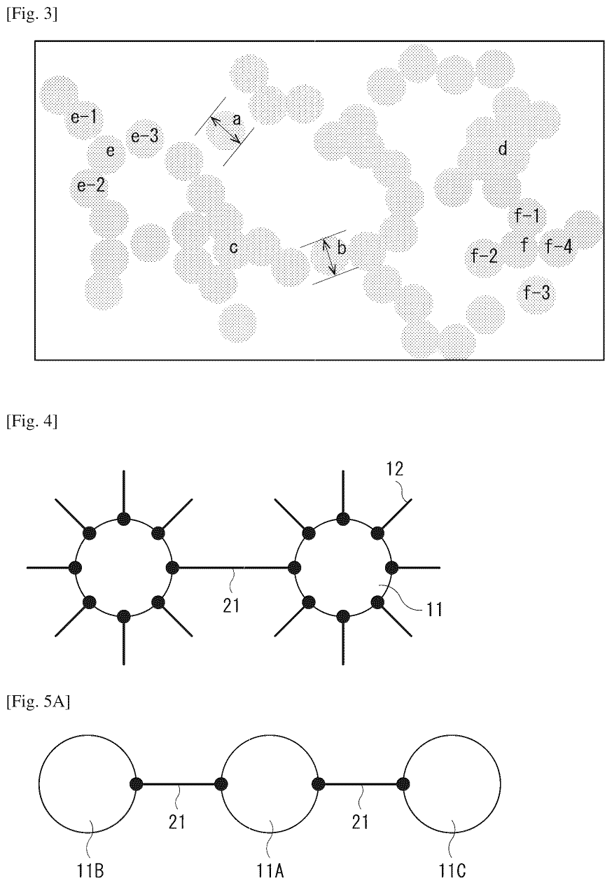

Next, 50 nanoparticles 11, of which diameters can be clearly confirmed in a direction of an observation surface, are selected from the taken TEM photograph. When the number of the nanoparticles 11, of which the diameters can be clearly confirmed, present inside photographed one field of view is less than 50, 50 nanoparticles 11, of which the diameters can be clearly confirmed in the direction of the observation surface, are selected from a plurality of fields of view. FIG. 3 is an image diagram of the TEM photograph of the structure 1 taken using a transmission electron microscope. For example, in FIG. 3, a nanoparticle a and a nanoparticle b, of which diameters can be clearly confirmed, are selected. Meanwhile, for example, as for a nanoparticle c and a nanoparticle d, the nanoparticles 11 overlap each other in a depth direction of observation and shapes thereof are not confirmable, and thus the nanoparticle c and the nanoparticle d are not suitable as measurement targets. The maximum diameter of each of the selected 50 nanoparticles 11 is measured.

Here, it is assumed that the maximum diameter is a maximum distance (so-called maximum Feret diameter) of distances between two parallel lines drawn from all angles to be tangent to the contour of the nanoparticle 11. In measuring the maximum diameter (maximum Feret diameter), the diameter of a particulate portion excluding a coated part (methylsilyl group 12) coating the surface of the nanoparticle 11 is measured. Determining a median of the 50 maximum diameters (maximum Feret diameters) thus determined allows for an average particle diameter (median diameter) of the nanoparticle 11.

As described above, the methylsilyl group 12 is used to coat the surfaces of the nanoparticles 11 in order to prevent bonding between the plurality of nanoparticles 11. Specific examples of the methylsilyl group 12 include a monomethylsilyl group, a dimethylsilyl group, and a trimethylsilyl group. An Si—C bond constituting the methylsilyl group is extremely stable, and does not disintegrate in a general environment. Therefore, coating the surface of the nanoparticle 11 with the methylsilyl group 12 improves stability of the nanoparticle 11.

It is to be noted that presence or absence of the methylsilyl group 12 coating the surface of the nanoparticle 11 and an aspect of the bonding between the nanoparticle 11 and the methylsilyl group 12 are able to be confirmed, for example, by component analysis or composition analysis. Examples of the component analysis and the composition analysis include Fourier transform infrared spectroscopy analysis (FT-IR), gas chromatography analysis (GC), X-ray photoelectron spectroscopy (XPS), nuclear magnetic resonance analysis (NMR), and energy-dispersive X-ray analysis (EDX). The presence or absence of the methylsilyl group 12 coating the surface of the nanoparticle 11 and the aspect of the boding between the nanoparticle 11 and the methylsilyl group 12 are able to be analyzed using one or a plurality of the above-mentioned analysis methods.

The cross-linking part 21 couples the plurality of nanoparticles 11 to each other as described above. Specifically, the cross-linking part 21 is an inorganic oxide covalently bonded directly to the nanoparticle 11, for example, as illustrated in FIG. 4. The cross-linking part 21 forms a covalent bond with one or two nanoparticles 11.

The length of the cross-linking part 21 is preferably smaller than half (½) of the average particle diameter (diameter) of the nanoparticle 11, for example. Specifically, as illustrated in FIG. 5A, the length of the cross-linking part 21 is preferably a length at which a nanoparticle 11B and a nanoparticle 11C are not in contact with each other, in a state where the two nanoparticles 11B and 11C are coupled to one nanoparticle 11A at respective farthest positions (diagonal positions) via the cross-linking parts 21. That is, the length of the cross-linking part 21 is preferably less than a circumference of 60□<(=fÎ6 of diameter) of the nanoparticle 11 (11A), as illustrated in FIG. 5B. This makes it possible to prevent aggregation of the plurality of nanoparticles 11 inside the structure 1.

Examples of such a cross-linking part 21 include a cross-linking agent having two or more reactive points. Examples of a cross-linking agent (inorganic oxide) that forms a covalent bond directly with the nanoparticle 11, among those mentioned above, include a silane compound represented by the following general formula (1) or general formula (2) and a polysiloxane compound represented by the following general formula (3), general formula (4), or general formula (5).

(Chemical Formula 1)

R¹ₓSi(OR²)_{4·|X}·c (1)

(Chemical Formula 2)

R¹ₓSiCl_{4·|X}·c (2)

(Chemical Formula 3)

(R²O)SiR₁²—(SiR₁²—O)ₙ—SiR¹₂(OR²)·c (3)

(Chemical Formula 4)

ClSiR¹₂—(SiR₁²—O)ₙ—SiR₁²Cl·c (4)

(Chemical Formula 5)

(R²O)SiO_{3/2})ₘ·c (5))

(R¹ is a methyl group. R² is any of a methyl group, an ethyl group, a propyl group, and an isopropyl group. X is an integer of 0 or 2 or less. n is an integer of 0 or 1 or more. m is any of 8, 10, and 12.)

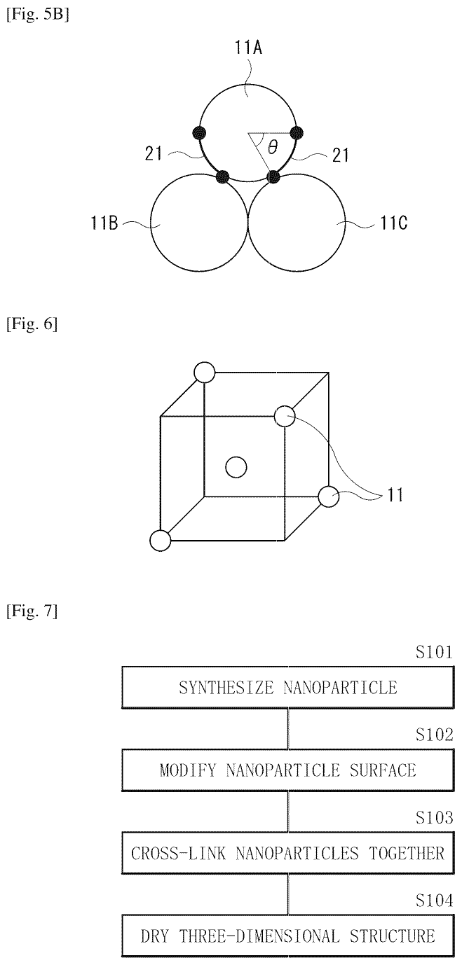

In the structure 1 of the present embodiment, the number of the nanoparticles 11 closest to one nanoparticle 11 is one to four, and four nanoparticles 11 have a diamond structure in the structure 1, for example, as illustrated in FIG. 6. Such a structure 1 has a porosity of 66% or more, for example, thereby enabling the structure 1 to obtain high light transmittance.

An air gap G formed in the structure 1 includes, for example, continuous fine pores. The fine pore has an average pore diameter of several nm to several tens of nm, for example. This allows the structure 1 to have a fine sponge-like bulk structure. Although air is usually present inside the air gap G, the air gap G can be evacuated, or, for example, a gas, having a lower thermal conductivity than that of air, such as helium (He) or argon (Ar) can be encapsulated thereinto, thereby further lowering the thermal conductivity of the structure 1.

The number of the nanoparticles 11 closest to one nanoparticle 11 can be confirmed, for example, as follows. First, in the same manner as in the case of determining the average particle diameter (median diameter) of the nanoparticle 11 described above, the structure 1 as a measurement target is subjected to working by a FIB method or the like to perform thinning. The cross-section of the obtained thinned sample is subjected to cross-sectional observation using a transmission electron microscope (Tecnai G2 manufactured by FEI Ltd.) to enable a plurality of nanoparticles 11 to be observed at an acceleration voltage of 200 kV and at a field of view of 50 nm·˜50 nm, whereby a TEM photograph is taken. It is assumed that the photographing position is selected at random from the thinned sample.

Next, 50 nanoparticles 11, of which diameters can be clearly confirmed in a direction of an observation surface, are selected from the taken TEM photograph. When the number of the nanoparticles 11, of which the diameters can be clearly confirmed in the direction of the observation surface, present inside photographed one field of view is less than 50, 50 nanoparticles 11, of which the diameters can be clearly confirmed in the direction of the observation surface, are selected from a plurality of fields of view. For example, in FIG. 3, a nanoparticle e and a nanoparticle f, of which diameters can be clearly confirmed in the direction of the observation surface, are selected. Meanwhile, for example, as for the nanoparticle c and the nanoparticle d, particles overlap each other in a depth direction of observation and positions of the particles are not correctly confirmable, and thus the nanoparticle c and the nanoparticle d are not suitable as measurement targets.

For each of the selected 50 nanoparticles 11, the number of nanoparticles (e.g., nanoparticles e-1, e-2, and e-3 and nanoparticles f-1, f-2, f-3, and f-4) present at positions closer than a certain distance to a nano particle (e.g., nanoparticle e and nanoparticle f) is measured. It is assumed here that the certain distance is 0.5 times the diameter of the nanoparticle 11, which is the maximum value of the length of the cross-linking part 21. It is difficult to directly confirm the presence of the cross-linking part 21 because no image thereof is photographed by the electron microscope. However, in a case where the cross-linking part 21 is not present, it is not possible to maintain a structure in which the nanoparticles 11 are coupled to each other. Therefore, it can be considered that the cross-linking part 21 is present between the nanoparticle 11 and the nanoparticle 11. That is, the number of the nanoparticles 11 closest to one nanoparticle 11 corresponds to the number of the nanoparticles 11 bonded together via the cross-linking parts 21.

It is to be noted that the number of the nanoparticles 11 closest to one nanoparticle 11, i.e., the number of the nanoparticles 11 bonded via the cross-linking parts 21 refers to the number of other nanoparticles 11 bonded to the one nanoparticle 11 via the cross-linking parts 21. For example, in a case where certain one nanoparticle 11 is bonded to only another one nanoparticle 11 via a plurality of cross-linking parts 21, the number of the nanoparticle 11 bonded to the nanoparticle 11 via the cross-linking part 21 is one. The “number of the nanoparticles 11 closest to one nanoparticle 11” is obtained by determining the simple average (arithmetic average) of the numbers of other nanoparticles 11 bonded via the cross-linking parts 21 to the respective 50 nanoparticles 11 thus determined.

In addition, in a case where a component other than the nanoparticle 11 and the methylsilyl group 12 coating the nanoparticle 11 is detected upon performing component analysis and composition analysis of the structure 1 using the above-described FT-IR, GC, XPS, NMR and EDX, the component can be considered to be derived from the cross-linking part 21. Thus, it can be appreciated that the cross-linking part 21 including this component is present between the nanoparticles 11.

It is to be noted that the number of the nanoparticles 11 closest to one nanoparticle 11 is not necessarily limited to four or less. For example, when the simple average (arithmetic average) of the numbers of the nanoparticles 11 closest to one nanoparticle 11 within one field of view is four or less, the nanoparticle 11, to which five or more nanoparticles 11 are closest, may be included within one field of view.

### 1-2. Method of Manufacturing Structure

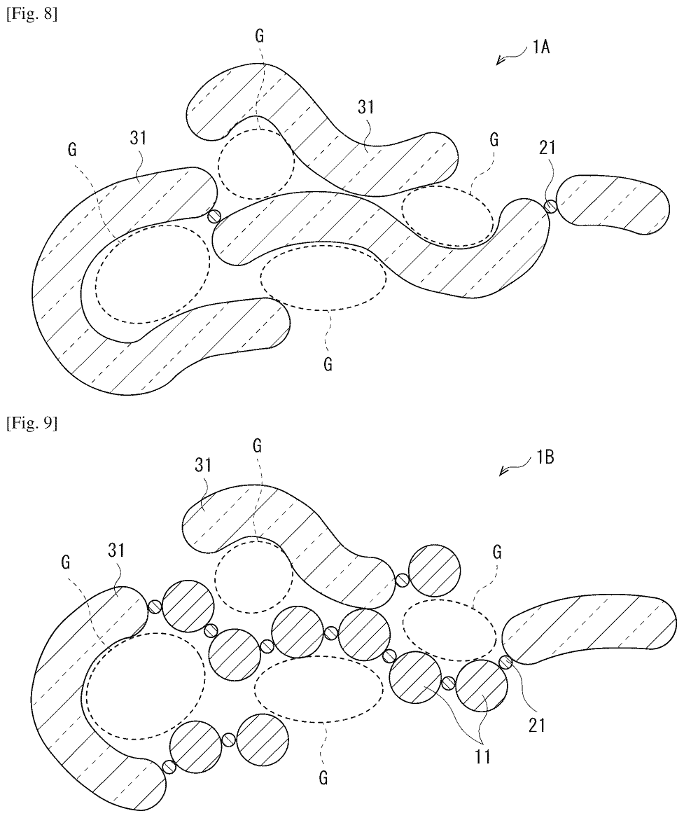

FIG. 7 illustrates a flowchart of manufacturing steps of the structure 1. (Synthesis of Nanoparticle)

First, the nanoparticle 11 (e.g., silica particle) is synthesized using a liquid phase method (step S101). In general, a method of manufacturing silica nanoparticles is roughly classified into two types: a gas phase method and a liquid phase method. As described above, a fine nanoparticle 11 having a diameter of 14 nm or less is able to be isolated without causing aggregation by using the liquid phase method. It is preferable to select, as a precursor in the liquid phase method, a molecule represented by the following general formula (6), which is able to form a three-dimensional polysiloxane skeleton (Si—O—Si) through a hydrolysis reaction and a condensation polymerization reaction. Examples of such a precursor include water glass (silicate soda (sodium silicate)) and an alkoxysilane molecule. The alkoxysilane molecule may be a molecule, in which some of alkoxy groups are substituted with methyl groups, and is no obstacle to the formation of the polysiloxane skeleton.

(Chemical Formula 6)

R₃^{y}Si(OR⁴)_{4·|Y}·c (6)

(R³ is a methyl group. R⁴ is any of a hydrogen atom, a methyl group, an ethyl group, a propyl group, and an isopropyl group. Y is an integer of 0 or 2 or less.)

After the above-described precursor is dissolved in water or an organic solvent, acidity or basicity is adjusted. Accordingly, silica particles are formed by a polymerization reaction. It is to be noted that, as long as the diameter of a final nanoparticle 11 is 14 nm or less, the method is not limited to the above-described manufacturing method. The followings are examples of reference literatures. For example, Literature 1 (T. Yokoi et al. Chem. Mater. 2009, 21, 3719-3729) reports formation of a nanoparticle having a diameter of 8 nm in an aqueous solution in the presence of an amino acid, in which the nanoparticle is surface-coated with an amino acid molecule, thereby enabling isolation without causing aggregation. Literature 2 (S. Sakamoto et al. Langmuir 2018, 34, 1711-1717) reports formation of a nanoparticle having a diameter of 3 nm by using an inverted micellar liquid crystal phase as a template, in which the nanoparticle is surface-coated with surfactant molecules, thereby enabling isolation of the nanoparticles without causing aggregation thereof.

### (Surface Modification of Nanoparticle)

Next, the nanoparticles 11 are dispersed in a solvent to modify the surfaces (step S102). For example, an amphipathic molecule such as a surfactant molecule, an amino acid molecule, or a macromolecule such as a block copolymer of a phospholipid or polyalkylene glycol is added to a dispersion liquid in which the nanoparticles 11 are dispersed. The added amphipathic molecule is adsorbed on the surface of the nanoparticle 11 to serve to prevent the aggregation of the nanoparticles. As in the above-mentioned Literatures 1 and 2, depending on a manufacturing method, the nanoparticle 11 surface-coated with the amphipathic molecule is obtained. In such a case, the addition of the amphipathic molecule is omitted.

(Cross-Linking between Nanoparticles)

Subsequently, a cross-linking agent (silane compound or polysiloxane compound) is used to cross-link the nanoparticles 11 together (step S103). The above-described silane compound or polysiloxane compound having two or more reactive points is added as a cross-linking agent to the dispersion liquid in which the nanoparticles 11 are dispersed, with each surface being coated with an amphipathic molecule such as a surfactant molecule, an amino acid molecule, or a macromolecule. The amount of the silane compound to be added is an amount by which one to four nanoparticles 11 are bonded to one nanoparticle 11. After the addition of the silane compound, the dispersion liquid is heated as needed. Thus, in the dispersion liquid, a cross-linking reaction of the nanoparticle 11 proceeds to form the structure 1 having a three-dimensional structure. The dispersion liquid gradually loses its fluidity to be brought into a gel state.

### (Drying of Three-Dimensional Structure)

Finally, the dispersion liquid brought into a gel state is dried to obtain the structure 1 (step S104). Examples of methods for drying and removing the solvent include drying at an elevated temperature under normal pressure. In a case where disintegration of the structure 1 due to interfacial tension during drying is feared, it is preferable to use a supercritical drying method or a freeze-drying method. In the present embodiment, the surface of the nanoparticle 11 (silica particle), which is a cause of large interfacial tension, is deactivated by being coated with the methylsilyl group 12. Therefore, the structure 1 is less likely to disintegrate during drying than in a case where the surface is not coated. Thus, the structure 1 illustrated in FIG. 1 is obtained.

It is to be noted that a water-repellent function can be added to the structure 1 as needed. As for the water repellency of the structure 1, for example, the nanoparticles 11 are cross-linked together in the above-described step S103. Thereafter, a methyl silane compound represented by the above-mentioned general formula (1) or general formula (2), or a methyl silane compound including a fluoro group as R¹ in the above-mentioned general formula (1) or general formula (2) is added to a dispersion liquid in which the nanoparticles 11 cross-linked by a cross-linking agent are dispersed, and the dispersion liquid is heated as needed. Examples of the fluoro group include 1H,1H,2H,2H-tridecafluoro-n-octyl, 1H,1H,2H,2H-heptadecafluorodecyl, pentafluorophenyl, 1H,1H,2H,2H-nonafluorohexyl, 3-(2,3,4,5,6-pentafluorophenyl)propyl, 11-pentafluorophenoxyundecyl, and 5,5,6,6,7,7,7-heptafluoro-4,4-bis(trifluoromethyl)heptyl. The amount of the organic silane compound to be added is not particularly limited. This reduces the percentage of the amphipathic molecule such as a surfactant molecule, an amino acid molecule, or a macromolecule coating the surface of the nanoparticle 11, thus improving weather resistance.

### 1-3. Workings and Effects

In the structure 1 of the present embodiment, the plurality of nanoparticles 11 are coupled to each other via the cross-linking part 21 including an inorganic oxide. This improves stability to an ultraviolet ray. This is described below.

In buildings such as ordinary houses and offices, the percentage of heat escaping to the outside during cooling and heating through an opening such as a glass window accounts for most of the heat escaping. For example, during heating, the heat loss rate through the opening accounts for 48% of the entire heat loss. During cooling, the heat acquisition rate through the opening accounts for 71% of the entire heat acquisition.

Examples of a proposed method for insulating the opening such as a glass window include a method in which a heat insulating film having an air gap structure is attached to a glass surface or a heat insulating material is interposed between double windows to improve heat insulating properties.

However, the heat insulating material currently used has an issue of greatly impaired degree of transparency due to insufficient transparency. The transparent heat insulating material currently used is configured by an aerogel in which silica particles are lined in a beaded shape to thereby form a porous structure. A typical aerogel has a beaded skeleton of a width of about 10 nm and has an air gap of about several tens of nm, and the aerogel scatters light depending on the thickness of the skeleton. The scattering intensity is proportional to the sixth power of the particle diameter, for example.

The aerogel is manufactured, for example, as follows. First, a silica alkoxide precursor is dissolved in a solvent such as ethanol, and particles are grown by hydrolysis and condensation polymerization to obtain nanoparticles. Thereafter, the nanoparticles are copolymerized together to form a skeleton, and are gelled. The resulting wet gel is subjected to supercritical drying to remove the solvent, for example, to thereby obtain a porous aerogel. In the above-described manufacturing method, the particle growth proceeds also in the steps of the skeleton formation and the drying, thus increasing the thickness of the skeleton of the aerogel and lowering the transparency.

In addition to the above-described heat insulating material of the heat insulating window, the aerogel has been attempted to be applied to a transmitting body or the like of a solar collector, for example. An aerogel to be used outdoors, such as the transmitting body of the solar collector, is required to have weather resistance.

However, an organic matter is used for the above-described typical aerogel, and thus deterioration in performance due to an ultraviolet ray and degradation in quality such as yellowing are feared.

In contrast, in the present embodiment, the plurality of nanoparticles 11 are coupled to each other via the cross-linking part 21 including an inorganic oxide such as a silane compound or a polysiloxane compound, for example. This improves stability to an ultraviolet ray.

As described above, in the structure 1 of the present embodiment, the plurality of nanoparticles 11 are coupled to each other via the cross-linking part 21 including the inorganic oxide, thus suppressing the degradation of quality due to an ultraviolet ray. That is, it is possible to provide the structure 1 having weather resistance.

In addition, in the present embodiment, the use of the plurality of nanoparticles 11 surface-coated with the methylsilyl group 12, which is extremely stable in the general environment, makes it possible to further improve the weather resistance.

Further, in the present embodiment, before the plurality of nanoparticles 11 having the beaded skeleton constituting the structure 1 are coupled to each other with a cross-linking agent, the surface is coated with an amphipathic molecule such as a surfactant molecule, an amino acid molecule, or a macromolecule. This makes it possible to prevent aggregation of the plurality of nanoparticles 11 in the cross-linking step and suppress particle growth. Thus, it is possible to provide the structure 1 having high light transmittance.

For example, in a case where the structure 1 of the present embodiment is attached to a glass window or interposed between double windows as described above, it is possible to suppress the heat balance of the glass window while ensuring higher light transmittance than in a case of using a typical aerogel, thus making it possible to improve cooling and heating efficiencies. Thus, it is possible to achieve both a reduction in the utility cost and environmental contribution.

In addition, for example, the use of the structure 1 of the present embodiment as a heat insulating material makes it possible to enhance the design of a product, such as a refrigerator or a bathtub, in which an opaque heat insulating material is generally used.

Next, description is given of a modification example of the foregoing embodiment. Hereinafter, components similar to those in the foregoing embodiment are denoted by the same reference numerals, and descriptions thereof are omitted as appropriate.

### 2. Modification Example

FIG. 8 schematically illustrates an example of a configuration of a structure (a structure 1A) according to a modification example of the present disclosure. In the same manner as the structure 1 in the foregoing embodiment, the structure 1A is used, for example, as a heat insulating material that suppresses heat balance of a window by being attached to a glass window or being interposed between double windows, or as a transmitting body of a solar collector. The structure 1A of the present modification example differs from the foregoing embodiment in that a plurality of nanofibers 31 is used instead of the plurality of nanoparticles 11.

The nanofiber 31 is a fibrous material having a length of 100 times or more the diameter, for example, and is a silica nanofiber, for example. The average diameter (fÓ) of the nanofiber 31 is, for example, 14 nm or less, and preferably 9 nm or less. In the same manner as the nanoparticle 11, the nanofiber 31 is surface-coated with the methylsilyl group 12, thus bringing the plurality of nanofibers 31 into a state of not being able to be covalently bonded to each other.

In the same manner as the foregoing embodiment, the plurality of nanofibers 31 are coupled to each other via the cross-linking part 21. The length of the cross-linking part 21 is preferably smaller than half (½) of the diameter (fO) of the nanofiber 31. This makes it possible to prevent aggregation of the plurality of nanofibers 31 inside the structure 1A.

For example, the nanofiber 31 is able to form a silica nanofiber having a diameter of 5 nm to 10 nm by using an inverted micellar liquid crystal phase as a template (Literature 3 (W.-C. Lai, L et al. J. Taiwan Inst. Chem. Eng. 2019, 99, 207-214)). In addition, for example, the nanofiber 31 is able to form a twisted rod-like silica nanofiber by utilizing self-assembly of aminopropyltrimethoxy silane (Literature 4 (Y. Kaneko et al. Chem. Mater. 2004, 16, 3417-3423)).

It is to be noted that above-described manufacturing method is exemplary, and this is not limitative as long as a the nanofiber 31 having a diameter of 14 nm or less is finally obtained.

As for the surface modification of the nanofiber 31, the cross-linking between the nanofibers 31 using a cross-linking agent, and the drying thereof, similar methods can be used to the above-described methods for the surface modification of the nanoparticle 11, the cross-linking between the nanoparticles 11 using a cross-linking agent, and the drying thereof.

It is to be noted that FIG. 8 illustrates an example of the structure 1A configured only by the nanofiber 31, but this is not limitative. For example, as in a structure 1B illustrated in FIG. 9, the nanoparticle 11 and the nanofiber 31 may be present in a mixed manner. Also in such a case, the nanoparticles 11 are coupled to each other, the nanofibers 31 are coupled to each other, and the nanoparticle 11 and the nanofiber 31 are coupled to each other, via the cross-linking part 21 described above.

As described above, in the structures 1A and 1B of the present modification example, some or all of the nanoparticles 11 are replaced with the nanofibers 31. The surface thereof is coated with the methylsilyl group 12. The nanoparticle 11 and the nanofiber 31 are coupled to each other, or the nanofibers 31 are coupled to each other, for example, via the cross-linking part 21 including an inorganic oxide such as a silane compound or a polysiloxane compound. This improves stability to an ultraviolet ray. Thus, it is possible to obtain effects similar to those of the foregoing embodiment.

### 3. Another Application Example

The structure (e.g., structure 1) described in any of the foregoing embodiment and modification example has a transmittance of 70% or more, for example, thereby enabling the structure 1 to be used for a window glass and the like of an automobile. Further, the structure 1 has a transmittance of 90% or more, for example, thereby enabling the structure 1 to be used, for example, for a window glass of a building or as an alternative material to a glass substrate or a plastic.

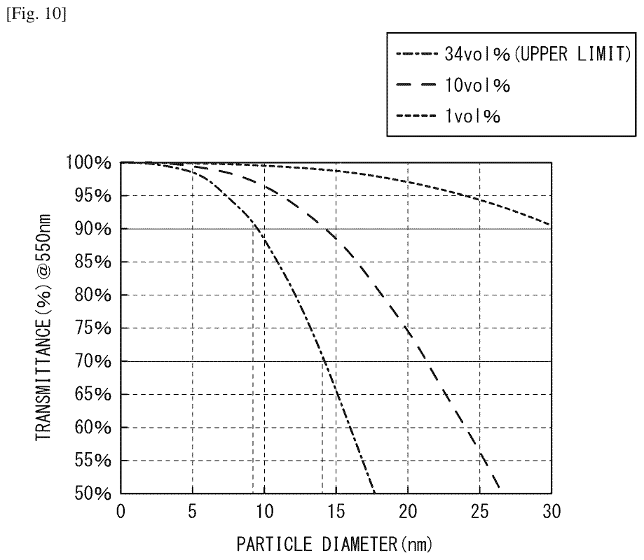

FIG. 10 illustrates transmittance for a wavelength of 550 nm when the structure 1 having a thickness of 1 mm is formed. For example, in a case where the number of the nanoparticles 11, of a plurality of nanoparticles 11 constituting the structure 1, closest to one nanoparticle 11 is four, the four nanoparticles 11 in the structure 1 have a diamond structure (see FIG. 6). In such a structure 1, the filling factor of the nanoparticles 11 is 34% by volume; as illustrated in FIG. 10, when the primary particle diameter is 14 nm, the structure 1 has a transmittance of 70%. Further, when the primary particle diameter is 9 nm, the structure 1 has a transmittance of 90%. Meanwhile, in a case where the number of the nanoparticles 11, of the plurality of nanoparticles 11 constituting the structure 1, closest to one nanoparticle 11 is less than four, the filling factor of the nanoparticles 11 in the structure 1 is less than 34% by volume. Therefore, in the same manner as the case where the number of the nanoparticles 11 closest to one nanoparticle 11 is four, when the primary particle diameter is 14 nm or less, the structure 1 has a transmittance of 70% or more. Further, when the primary particle diameter is 9 nm or less, the structure 1 has a transmittance of 90% or more.

Although the description has been given hereinabove of the present disclosure with reference to the embodiment and modification example, the present disclosure is not limited to the foregoing embodiment and the like, and may be modified in a wide variety of ways. For example, the foregoing embodiment or the like exemplifies a silica particle as the nanoparticle 11 and a silica nanofiber as the nanofiber 31, but this is not limitative. It may also be possible to use a nanoparticle or nanofiber including an inorganic oxide, an inorganic nitride, an inorganic carbide or an organic matter. In addition, the structure (e.g., structure 1) of the present disclosure may be configured by, for example, a plurality of types of nanoparticles and/or nanofibers for which the above-described materials are appropriately selected.

In addition, in the foregoing embodiment and the like, reference has been made, as application examples of the structure 1, to the attachment to a glass window, the arrangement between double windows, the heat insulating material for a refrigerator, a bathtub or the like, and a transmitting body of a solar collector, for example; however, the structure 1 or the like of the present disclosure may be used, as a functional member other than the heat insulating material or the transmitting body, for other electronic apparatuses and the like. For example, the structure 1 has applications similar to those of typical porous materials, such as an adsorbent of an odorous component, bacteria, and virus; a hygroscopic material that controls air humidity to be constant; and sound-absorbing material that prevents a sound wave from traveling. In addition, the structure 1 is able to be used for an application requiring transparency, and thus is also applicable to a photocatalyst, artificial photosynthesis, a structural material for an electronic apparatus such as a solar cell or a semiconductor, as well as to a material of a low dielectric constant film or a material for an antireflection film.

It is to be noted that the effects described herein are merely exemplary and should not be limited thereto, and may further include other effects.

It is to be noted that the present technology may also have the following configurations. According to the present technology of the following configurations, the plurality of nanoparticles or the plurality of nanofibers are coupled to each other via the cross-linking agent including an inorganic oxide, thereby improving stability to an ultraviolet ray. Thus, it is possible to provide a heat insulating material having weather resistance.

(1)

A nanomaterial structure comprising:
a nanomaterial including a nanomaterial surface;
a silyl compound provided on the nanomaterial surface; and a nanomaterial cross-linking part, wherein the nanomaterial is cross-linked with the nanomaterial cross-linking part.

(2)

The nanomaterial structure according to (1), wherein the nanomaterial is cross-linked with the nanomaterial cross-linking part via a covalent bond.

(3)

The nanomaterial structure according to (1) or (2), wherein the nanomaterial cross-linking part includes an inorganic oxide covalently bonded directly to the nanomaterial.

(4)

The nanomaterial structure according to (3), wherein the inorganic oxide includes a silane compound or a polysiloxane compound.

(5)

The nanomaterial structure according to any one of (1) to (4), wherein the nanomaterial cross-linking part is bonded to the nanomaterial at one or two locations.

(6)

The nanomaterial structure according to any one of (1) to (5), wherein a length of the nanomaterial cross-linking part is smaller than ½ of an average particle diameter of the nanomaterial.

(7)

The nanomaterial structure according to any one of (1) to (6), wherein an average particle diameter of the nanomaterial is 14 nm or less.

(8)

The nanomaterial structure according to any one of (1) to (6), wherein an average particle diameter of the nanomaterial is 9 nm or less.

(9)

The nanomaterial structure according to any one of (1) to (8), wherein the nanomaterial includes at least one of a plurality of nanoparticles, nanofibers or nanosheets having a surface coated with the silyl compound and that are cross-linked with the nanomaterial cross-linking part.

(10)

The nanomaterial structure according to any one of (1) to (9), wherein the silyl compound includes a methyl silyl compound.

(11)

A porous film comprising:
a nanomaterial having a nanomaterial surface;
a silyl compound provided on the nanomaterial surface; and
a nanomaterial cross-linking part, wherein the nanomaterial is cross-linked with the nanomaterial cross-linking part.

(12)

The porous film according to (11), wherein the porous film is an antireflection film or a protective sheet.

(13)

A porous material comprising:
a nanomaterial having a nanomaterial surface;
a silyl compound provided on the nanomaterial surface; and
a nanomaterial cross-linking part, wherein the nanomaterial is cross-linked with the nanomaterial cross-linking part.

(14)

The porous material according to (13), wherein the porous material is a heat insulating material, an adsorbent material, a hygroscopic material or a sound-absorbing material.

(15)

The porous material according to (13), wherein the porous material is a transparent material including a photocatalyst material, an artificial photosynthesis material, a material for an electronic apparatus including a solar cell material, a semiconductor material, or a low dielectric constant film material.

(16)

A method of manufacturing a nanomaterial structure comprising:
providing a nanomaterial including a nanomaterial surface; and
providing a silyl compound on the nanomaterial surface to form a coated nanomaterial.

(17)

The method according to (16) further comprising:
providing a cross-linking agent; and
forming a nanomaterial cross-linked structure by cross-linking the coated nanomaterial with the cross-linking agent.

(18)

The method according to (17), further comprising:
drying the nanomaterial cross-linked structure.

(19)

The method according to (18), further comprising:
forming a porous film or a porous material from the nanomaterial cross-linked structure.

(20)

The method according to (19), wherein the porous film or the porous material is an antireflection film, a protective sheet, a heat insulating material, an adsorbent material, a hygroscopic material, a sound-absorbing material, or a transparent material including a photocatalyst material, an artificial photosynthesis material, a material for an electronic apparatus including a solar cell material, a semiconductor material, or a low dielectric constant film material.

(21)

A method of manufacturing a nanomaterial structure comprising:
providing a nanomaterial including a nanomaterial surface and a silyl compound provided on the nanomaterial surface;
providing a cross-linking agent; and
forming the nanomaterial structure by cross-linking the nanomaterial with the cross-linking agent.

(22)

A method of manufacturing a nanomaterial structure comprising:
forming the nanomaterial structure by drying a nanomaterial cross-linked structure, wherein the nanomaterial cross-linked structure includes a nanomaterial including a nanomaterial surface and a silyl compound provided on the nanomaterial surface, and wherein the nanomaterial is cross-linked with a cross-linking agent.

(23)

A method of manufacturing a product comprising:
forming the product from a nanomaterial structure, wherein the nanomaterial structure includes a nanomaterial including a nanomaterial surface and a silyl compound provided on the nanomaterial surface, wherein the nanomaterial is cross-linked with a cross-linking agent, and wherein the nanomaterial structure has been dried.

(24)

A nanomaterial structure comprising:
a nanomaterial; and
a nanomaterial cross-linking part including an inorganic oxide, wherein the nanomaterial is cross-linked with the nanomaterial cross-linking part.

(25)

The nanomaterial structure according to (24), wherein the nanomaterial is cross-linked with the nanomaterial cross-linking part via a covalent bond.

(26)

The nanomaterial structure according to (25), wherein the nanomaterial cross-linking part is covalently bonded directly to the nanomaterial.

(27)

The nanomaterial structure according to any one of (24) to (26), wherein the inorganic oxide includes a silane compound or a polysiloxane compound.

(28)

The nanomaterial structure according to any one of (24) to (27), wherein the nanomaterial cross-linking part is bonded to the nanomaterial at one or two locations.

(29)

The nanomaterial structure according to any one of (24) to (28), wherein a length of the nanomaterial cross-linking pat is smaller than ½ of an average particle diameter of the nanomaterial.

(30)

The nanomaterial structure according to any one of (24) to (29), wherein an average particle diameter of the nanomaterial is 14 nm or less.

(31)

The nanomaterial structure according to any one of (24) to (29), wherein an average particle diameter of the nanomaterial is 9 nm or less.

(32)

The nanomaterial structure according to any one of (24) to (31), wherein the nanomaterial includes at least one of a plurality of nanoparticles, nanofibers or nanosheets.

(33)

The nanomaterial structure according to any one of (24) to (32), wherein the nanomaterial including a nanomaterial surface, and wherein a silyl compound is provided on the nanomaterial surface.

(34)

A porous film comprising:
a nanomaterial; and
a nanomaterial cross-linking part including an inorganic oxide, wherein the nanomaterial is cross-linked with the nanomaterial cross-linking part.

(35)

The porous film according to (34), wherein the inorganic oxide includes a silane compound or a polysiloxane compound.

(36)

The porous film according to (34) or (35), wherein the porous film is an antireflection film or a protective sheet.

(37)

A porous material comprising:
a nanomaterial; and
a nanomaterial cross-linking part including an inorganic oxide, wherein the nanomaterial is cross-linked with the nanomaterial cross-linking part.

(38)

The porous material according to (37), wherein the inorganic oxide includes a silane compound or a polysiloxane compound.

(39)

The porous material according to (37) or (38), wherein the porous material is a heat insulating material, an adsorbent material, a hygroscopic material or a sound-absorbing material.

(40)

The porous material according to (37) or (38), wherein the porous material is a transparent material including a photocatalyst material, an artificial photosynthesis material, a material for an electronic apparatus including a solar cell material, a semiconductor material, or a low dielectric constant film material.

(41)

A method of manufacturing a nanomaterial structure comprising:
providing a nanomaterial;
providing a cross-linking agent including an inorganic oxide; and forming a nanomaterial cross-linked structure by cross-linking the nanomaterial with the cross-linking agent.

(42)

The method according to (41), further comprising:
drying the nanomaterial cross-linked structure.

(43)

The method according to (42), further comprising:
forming a porous film or a porous material from the nanomaterial cross-linked structure.

(44)

The method according to (43), wherein the porous film or the porous material is an antireflection film, a protective sheet, a heat insulating material, an adsorbent material, a hygroscopic material, a sound-absorbing material, or a transparent material including a photocatalyst material, an artificial photosynthesis material, a material for an electronic apparatus including a solar cell material, a semiconductor material, or a low dielectric constant film material.

(45)

A method of manufacturing a nanomaterial structure comprising:
forming the nanomaterial structure by drying a nanomaterial cross-linked structure, wherein the nanomaterial cross-linked structure includes a nanomaterial that is cross-linked with a cross-linking agent including an inorganic oxide.

(46)

A method of manufacturing a product comprising:
forming the product from a nanomaterial structure, wherein the nanomaterial structure includes a nanomaterial that is cross-linked with a cross-linking agent including an inorganic oxide, and wherein the nanomaterial structure has been dried.

(47)

A structure including:
a plurality of nanoparticles or a plurality of nanofibers; and
a cross-linking part including an inorganic oxide, the cross-linking part coupling the plurality of nanoparticles or the plurality of nanofibers to each other.

(48)

The structure according to (47), in which the plurality of nanoparticles or the plurality of nanofiber are surface-coated with a methylsilyl group.

(49)

The structure according to (47) or (48), in which the inorganic oxide includes a silane compound or a polysiloxane compound.

(50)

The structure according to any one of (47) to (49), in which the cross-linking part forms a covalent bond directly with the nanoparticles or the nanofibers.

(51)

The structure according to any one of (47) to (50), in which the cross-linking part is bonded to the nanoparticles or the nanofibers at one or two locations.

(52)

The structure according to any one of (47) to (51), in which an average value of the numbers of the nanoparticles closest to a corresponding one of the nanoparticles is one or more and four or less.

(53)

The structure according to any one of (47) to (52), in which a length of the cross-linking part is smaller than ½ of an average particle diameter of the plurality of nanoparticles.

(54)

The structure according to any one of (47) to (51), in which a length of the cross-linking part is smaller than ½ of an average diameter of the plurality of nanofibers.

(55)

The structure according to any one of (47) to (53), in which the average particle diameter of the plurality of nanoparticles is 14 nm or less.

(56)

The structure according to any one of (47) to (53), in which the average particle diameter of the plurality of nanoparticles is 9 nm or less.

(57)

The structure according to any one of (47) to (51) or (54), in which the average diameter of the plurality of nanofibers is 14 nm or less.

(58)

The structure according to any one of (47) to (57), in which
the structure includes both of the plurality of nanoparticles and the plurality of nanofibers, and
the nanoparticles and the nanofibers are partially coupled via the cross-linking part.

(59)

A method of manufacturing a structure, the method including coupling a plurality of nanoparticles or a plurality of nanofibers to each other via a cross-linking part including a cross-linking agent by adding the cross-linking agent including an inorganic oxide.

(60)

The method of manufacturing the structure according to (59), in which, after the coupling between the plurality of nanoparticles or between the plurality of nanofibers via the cross-linking part, a methylsilane compound is added, and is adsorbed to surfaces of the plurality of nanoparticles or the plurality of nanofibers.

(61)

The method of manufacturing the structure according to (59) or (60), in which, before the coupling between the plurality of nanoparticles or between the plurality of nanofibers, an amphipathic molecule is added to a dispersion liquid, in which the plurality of nanoparticles or the plurality of nanofibers are dispersed, and is adsorbed to the surfaces of the plurality of nanoparticles or the plurality of nanofibers.

(62)

A heat insulating material including a structure, the structure including a plurality of nanoparticles or a plurality of nanofibers, and a cross-linking part including an inorganic oxide, the cross-linking part coupling the plurality of nanoparticles or the plurality of nanofibers to each other.

The present technology relates to Goal 13·CLIMATE ACTION·h and Goal 07·Affordable and Clean Energy·h of the SDGs (Sustainable Development Goals) adopted at the United Nations Summit in 2015, given the structure and characteristics of the nanomaterial structure including a nanomaterial and applications thereof. For example, the nanomaterial structure is transparent and has a heat insulation property that makes it ideal for use (e.g., as applied to a surface) for any suitable glass material (e.g., a window, such as, a window for residential, commercial, and vehicle use (e.g., a car) for energy efficiency purpose. In conventional glass material, there is a problem that the energy consumption for indoor air cooling/heating purpose increases due to a large amount of heat flowing in/out of the window during indoor air heating/cooling process. By using the nanomaterial structure of the present technology in combination with a suitable glass material (e.g., window), less energy consumption should be required for indoor air heating/cooling purpose thereby further contributing to a reduction of CO₂ emissions from power generation that utilize combustion of fossil fuels. Further, for example, the nanomaterial structure of the present technology can be utilized as a transparent plate of a solar collector to enhance the energy efficiency (e.g., heat collection efficiency) of the solar collector, and thus contributing to a reduction of energy consumption derived from fossil fuels and thereby a reduction in CO₂ emissions.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1, 1A, 1B structure
11 nanoparticle
12 methylsilyl group
21 cross-linking part
31 nanofiber

1. A nanomaterial structure comprising:
a nanomaterial; and
a nanomaterial cross-linking part including an inorganic oxide, wherein the nanomaterial is cross-linked with the nanomaterial cross-linking part.

2. The nanomaterial structure according to claim 1, wherein the nanomaterial is cross-linked with the nanomaterial cross-linking part via a covalent bond.

3. The nanomaterial structure according to claim 2, wherein the nanomaterial cross-linking part is covalently bonded directly to the nanomaterial.

4. The nanomaterial structure according to claim 1, wherein the inorganic oxide includes a silane compound or a polysiloxane compound.

5. The nanomaterial structure according to claim 1, wherein the nanomaterial cross-linking part is bonded to the nanomaterial at one or two locations.

6. The nanomaterial structure according to claim 1, wherein a length of the nanomaterial cross-linking part is smaller than ½ of an average particle diameter of the nanomaterial.

7. The nanomaterial structure according to claim 1, wherein an average particle diameter of the nanomaterial is 14 nm or less.

8. The nanomaterial structure according to claim 1, wherein an average particle diameter of the nanomaterial is 9 nm or less.

9. The nanomaterial structure according to claim 1, wherein the nanomaterial includes at least one of a plurality of nanoparticles, nanofibers or nanosheets.

10. The nanomaterial structure according to claim 1, wherein the nanomaterial includes a nanomaterial surface; and wherein a silyl compound is provided on the nanomaterial surface.

11. A porous film comprising:
a nanomaterial; and
a nanomaterial cross-linking part including an inorganic oxide, wherein the nanomaterial is cross-linked with the nanomaterial cross-linking part.

12. The porous film according to claim 11, wherein the inorganic oxide includes a silane compound or a polysiloxane compound.

13. The porous film according to claim 11, wherein the porous film is an antireflection film or a protective sheet.

14. A porous material comprising:
a nanomaterial; and
a nanomaterial cross-linking part including an inorganic oxide, wherein the nanomaterial is cross-linked with the nanomaterial cross-linking part.

15. The porous material according to claim 14, wherein the inorganic oxide includes a silane compound or a polysiloxane compound.

16. The porous material according to claim 14, wherein the porous material is a heat insulating material, an adsorbent material, a hygroscopic material or a sound-absorbing material.

17. The porous material according to claim 14, wherein the porous material is a transparent material including a photocatalyst material, an artificial photosynthesis material, a material for an electronic apparatus including a solar cell material, a semiconductor material, or a low dielectric constant film material.

18. A method of manufacturing a nanomaterial structure comprising:
providing a nanomaterial;
providing a cross-linking agent including an inorganic oxide; and
forming a nanomaterial cross-linked structure by cross-linking the nanomaterial with the cross-linking agent.

19. The method according to claim 18, further comprising:
drying the nanomaterial cross-linked structure.

20. The method according to claim 19, further comprising:
forming a porous film or a porous material from the nanomaterial cross-linked structure.

21. The method according to claim 20, wherein the porous film or the porous material is an antireflection film, a protective sheet, a heat insulating material, an adsorbent material, a hygroscopic material, a sound-absorbing material, or a transparent material including a photocatalyst material, an artificial photosynthesis material, a material for an electronic apparatus including a solar cell material, a semiconductor material, or a low dielectric constant film material.

22. A method of manufacturing a nanomaterial structure comprising:
forming the nanomaterial structure by drying a nanomaterial cross-linked structure, wherein the nanomaterial cross-linked structure includes a nanomaterial that is cross-linked with a cross-linking agent including an inorganic oxide.

23. A method of manufacturing a product comprising:
forming the product from a nanomaterial structure, wherein the nanomaterial structure includes a nanomaterial that is cross-linked with a cross-linking agent including an inorganic oxide, and wherein the nanomaterial structure has been dried.
